(19) United States
(12) Patent Application Publication
(10) Pub. No.: US 2018/0010513 A1
(43) Pub. Date: Jan. 11, 2018

(54) APPARATUS AND METHOD FOR REDUCING RATTLE NOISE OF AUTOMOTIVE TURBOCHARGER

(71) Applicant: Hyundai Motor Company, Seoul (KR)

(72) Inventor: Jeong Kyu LIM, Suwon-si (KR)

(73) Assignee: Hyundai Motor Company, Seoul (KR)

(21) Appl. No.: 15/340,053

(22) Filed: Nov. 1, 2016

(30) Foreign Application Priority Data
Jul. 8, 2016 (KR) 10-2016-0086537

(51) Int. Cl. F02B 37/18

(52) U.S. Cl. CPC F02B 37/186

(57) ABSTRACT

The present disclosure provides an apparatus and a method for reducing rattle noise of an automotive turbocharger. The apparatus and the method may reduce the occurrence of rattle noise, caused by exhaust gas passing through an exhaust bypass hole, by bidirectionally controlling an opening angle of a waste gate valve by an actuator. The actuator may utilize a bidirectional motor so that the waste gate valve may operate in a direction in which the exhaust bypass hole is opened as well as in a direction in which the exhaust bypass hole is closed. Further, the rattle noise can be reduced by a valve stopper which supports the rear side of the waste gate valve in an opened state, the valve stopper is provided at an appropriate position of a turbine housing.

### CROSS-REFERENCE TO RELATED APPLICATION

This application claims priority to and the benefit of Korean Patent Application No. 10-2016-0086537, filed on Jul. 8, 2016, the entire contents of which are incorporated herein by reference.

### FIELD

The present disclosure relates to an apparatus and a method for reducing rattle noise of an automotive turbocharger.

### BACKGROUND

The statements in this section merely provide background information related to the present disclosure and may not constitute prior art.

In general, a turbocharger serves to recover flow energy of exhaust gas discharged from an engine, compress intake air, and supply the compressed intake air to the engine. The turbocharger operates a turbine mounted on an engine exhaust side by using flow energy of exhaust gas, compresses the intake air by using a compressor coaxially connected with the turbine, and supplies the compressed intake air to the engine, thereby improving engine output.

In the turbocharger, the turbine and the compressor are operated by pressure of an engine exhaust gas at the same time, and the compressor compresses the intake air and supplies it into a combustion chamber of the engine (i.e., supercharging). A large amount of air is supplied into the combustion chamber of the engine by the supercharging, and as a result, intake efficiency may be improved, and engine output may be increased.

In this case, in order to inhibit or prevent excessively increased boost pressure from being sent to the engine by the compressor, the turbocharger adopts a waste gate valve which serves as an exhaust bypass valve that discharges excessive exhaust gas of exhaust gas used to operate the turbine when the boost pressure being sent to the engine becomes equal to or higher than a predetermined pressure.

The waste gate valve in the related art may be classified into a mechanical waste gate valve and an electronic waste gate valve.

In the case of the electronic waste gate valve, valve operating force is applied by an operation of an actuator only in a direction in which an exhaust bypass hole for bypassing and discharging excessive exhaust gas is closed. In contrast, the exhaust bypass hole is opened by flow pressure of exhaust gas, without operation of any designated actuator or device. In particular, the waste gate valve is pushed and opened by exhaust gas pressure even though designated valve operating force does not apply to open the exhaust bypass hole.

The electronic waste gate valve closes the exhaust bypass hole by receiving driving power generated by the actuator, and several components are connectedly installed between the valve and the actuator in order to operate the valve.

We have discovered that the electronic waste gate valve in the related art has problems in that the exhaust gas, which has passed through the exhaust bypass hole, generates vibration while colliding with a lower end of the valve when opening the exhaust bypass hole, and the vibration is transmitted to the components between the valve and the actuator, which causes vibrating noise or rattle noise due to clearances between the components.

The above information disclosed in this Background section is only for enhancement of understanding of the background of the present disclosure and therefore it may contain information that does not form the prior art that is already known to a person of ordinary skill in the art.

### SUMMARY

The present disclosure provides an apparatus and a method for reducing rattle noise of an automotive turbocharger, which may reduce the occurrence of rattle noise caused by exhaust gas passing through an exhaust bypass hole, by bidirectionally controlling an opening angle of a waste gate valve by applying an actuator using a bidirectional motor so that the waste gate valve may operate in a direction in which the exhaust bypass hole is opened as well as in a direction in which the exhaust bypass hole is closed, and/or by forming a valve stopper for supporting the rear side of the waste gate valve, which is in an opened state, at an appropriate position of a turbine housing in consideration of a direction in which the waste gate valve is opened.

In one aspect, the present disclosure provides an apparatus for reducing rattle noise of an automotive turbocharger, the apparatus including: a waste gate valve configured to open and close an exhaust bypass hole formed in a turbine housing; an actuator configured to operate the waste gate valve by driving power generated by the actuator; a valve stopper formed on the turbine housing, and configured to support the waste gate valve; and a control unit configured to control the actuator.

In one form, the actuator may include a bidirectional motor configured to selectively generate driving power for opening and closing the waste gate valve.

In another form, the control unit may control the actuator based on engine intake pressure, and when the engine intake pressure is equal to or higher than a predetermined pressure, the control unit may operate the actuator to control the waste gate valve to open the exhaust bypass hole.

In another aspect, the present disclosure provides a method for reducing rattle noise of an automotive turbocharger, the method including: a first step of detecting engine intake pressure compressed and generated by a turbocharger; a second step of operating an actuator configured to operate a waste gate valve based on the engine intake pressure, the waste gate configured to open and close an exhaust bypass hole of the turbocharger; and a third step of supporting the waste gate valve, which is in an open position of the waste gate valve, by a valve stopper.

In the second step, the waste gate vale opens the exhaust bypass hole when the engine intake pressure is equal to or higher than a predetermined pressure.

According to the apparatus and the method for reducing rattle noise of an automotive turbocharger, since the waste gate valve is seated on and supported by the valve stopper, valve vibration caused by exhaust gas passing through the exhaust bypass hole is inhibited or prevented, and a cause of the occurrence of rattle noise (e.g., the waste gate valve's vibration) may be removed, thereby reducing rattle noise significantly.

In the present disclosure, since a maximum opening angle of the waste gate valve may be mechanically controlled by the valve stopper, the maximum opening angle of the waste gate valve may be restricted, and as a result, it is possible to inhibit or prevent permanent deformation of the waste gate valve which may be caused when the valve is forcedly and widely opened by high-pressure exhaust gas.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a turbocharger to which a rattle noise reduction apparatus for a turbocharger is applied;

FIG. 2 is a conceptual view illustrating a basic operating mechanism of the turbocharger illustrated in FIG. 1;

FIG. 3 is a view when viewing the turbocharger in FIG. 1 in a different direction;

FIGS. 4A-4B are views illustrating states in which a waste gate valve disposed in a turbine housing of the turbocharger is opened or closed, respectively; and

FIG. 5 is a configuration diagram illustrating some configurations of the rattle noise reduction apparatus for a turbocharger.

The drawings described herein are for illustration purposes only and are not intended to limit the scope of the present disclosure in any way.

### DETAILED DESCRIPTION

Hereinafter reference will now be made in detail to various forms of the present disclosure, examples of which are illustrated in the accompanying drawings and described below. While the present disclosure will be described in conjunction with exemplary forms, it will be understood that present description is not intended to limit the present disclosure to those exemplary forms. The present disclosure is intended to cover not only the exemplary forms, but also various alternatives, modifications, equivalents and other forms, which may be included within the spirit and scope of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

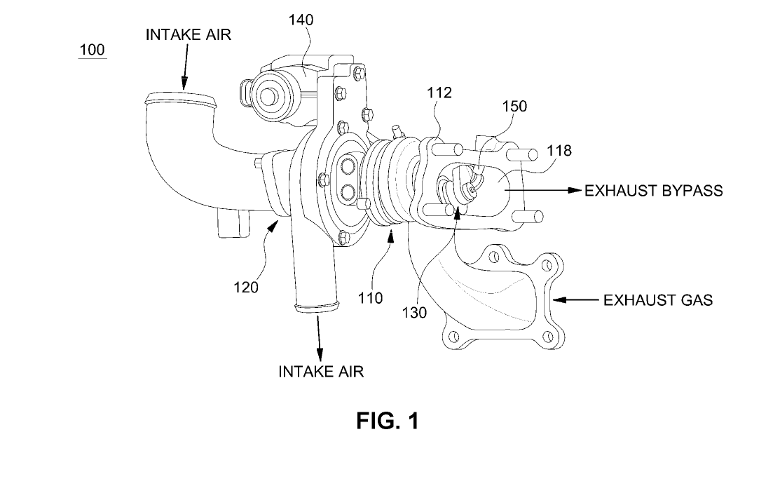

First, to help understand the present disclosure, a turbocharger will be described with reference to the attached FIGS. 1 to 3.

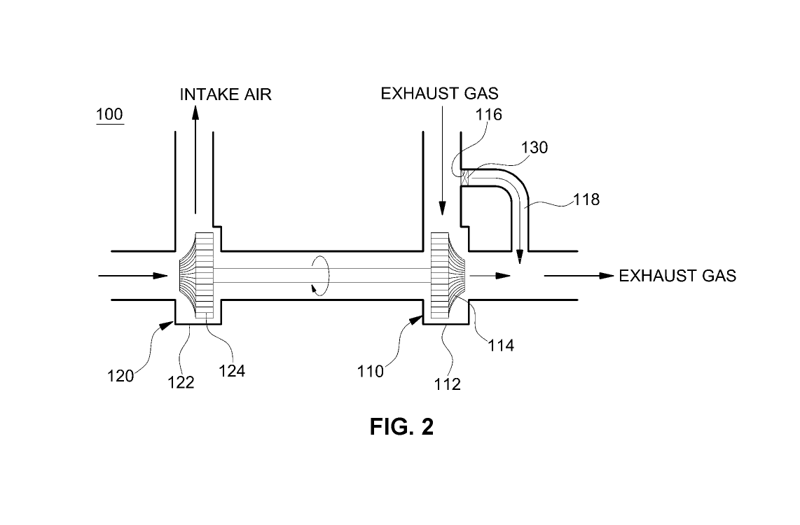

As illustrated in FIGS. 1 and 2, a turbocharger 100 includes: a turbine 110; and a compressor 120 coaxially connected to the turbine 110. The turbine 110, which is mounted on an engine exhaust pipe side, is operated by flow energy of exhaust gas, and at the same time, the compressor 120 is operated to compress intake air to be supplied to the engine.

Referring to FIG. 2, the turbine 110 has a turbine wheel 114 which is installed in a turbine housing 112 and rotated by flow energy of exhaust gas, and the compressor 120 has a compressor wheel 124 which is installed in a compressor housing 122 and rotated by being coaxially connected with the turbine wheel 114 so as to compress intake air and supply the compressed intake air to the engine.

To inhibit or prevent excessively increased boost pressure from being sent to the engine by the compressor 120, the turbocharger 100 is configured to bypass and discharge excessive exhaust gas of exhaust gas used to operate the turbine 110 when boost pressure being sent to the engine becomes equal to or more than a predetermined pressure. As such, the turbocharger 100 is configured to control the amount of exhaust gas at an appropriate level desired to operate the turbine 110.

To bypass and discharge excessive exhaust gas as described above, an exhaust bypass hole 116 is formed in the turbine housing 112, and a waste gate valve 130 configured to open and close the exhaust bypass hole 116 is installed.

Such as, the waste gate valve 130 in the turbocharger 100 functions as an exhaust bypass valve for discharging excessive exhaust gas when the turbine 110 is operated.

The waste gate valve 130 is operated by an actuator 140 (i.e., driving power of the actuator for operating the waste gate valve), and closes the exhaust bypass hole 116.

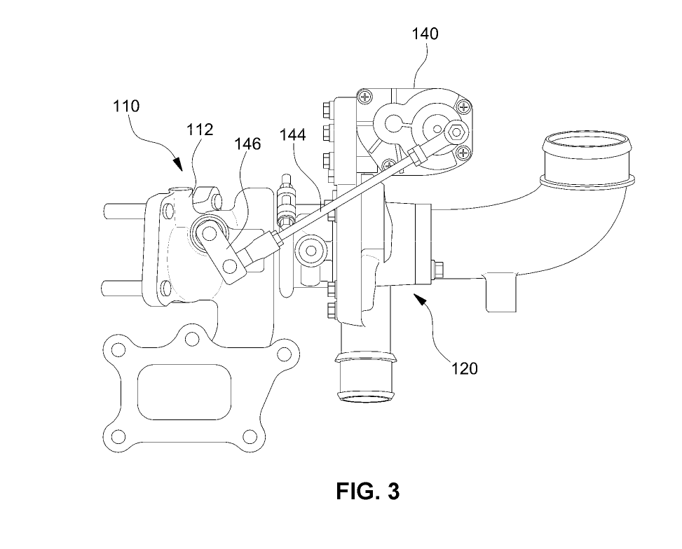

Referring to FIG. 3, the actuator 140 for opening and closing the waste gate valve 130 is provided on one side of the turbocharger 100, and a rod 144 and a crank 146 are operatively connected each other and installed between the actuator 140 and the waste gate valve 130. When the rod 144 rotates the crank 146 under a condition in which the actuator 140 operates, the waste gate valve 130 coaxially connected to a rotation center point of the crank 146 closes the exhaust bypass hole 116 while rotating.

Because the waste gate valve 130 is opened in a flow direction of exhaust gas passing through the exhaust bypass hole 116, the waste gate valve 130 can close the exhaust bypass hole 116 by valve operating force (e.g., force from an actuator), whereas the exhaust bypass hole 116 may be opened by flow pressure of exhaust gas which applies on the waste gate valve 130, without assistance of the valve operating force.

However, in a case in which the waste gate valve is pushed and opened by flow pressure of exhaust gas passing through the exhaust bypass hole, the exhaust gas strikes the waste gate valve while passing through the exhaust bypass hole. We have discovered that this phenomenon causes vibration and rattle noise of the waste gate valve, and the vibration is transmitted to components installed between the waste gate valve and the actuator, which causes rattle noise of the rod and the crank due to clearances between the components.

The present disclosure addresses a cause of the occurrence of vibration and noise to reduce the rattle noise generated when the waste gate valve 130 is opened.

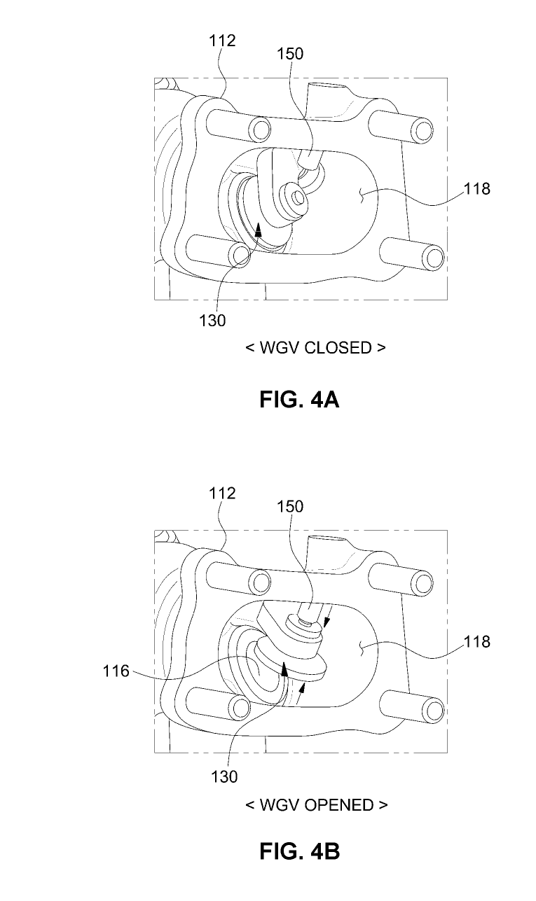

As illustrated in FIG. 1 and FIGS. 4A-4B, a valve stopper 150, which supports the waste gate valve 130 that has opened the exhaust bypass hole 116, is provided at a predetermined position of the turbine housing 112 in which the waste gate valve 130 is installed.

The waste gate valve 130 is installed in the turbine housing 112 so as to be able to open and close the exhaust bypass hole 116 by driving power from the actuator 140, and the valve stopper 150 is disposed in the vicinity of the exhaust bypass hole 116 in consideration of a direction in which the waste gate valve 130 is rotated and tilted by the crank 146 to open the exhaust bypass hole 116.

Specifically, a bypass flow path 118, which allows the exhaust gas to be bypassed and discharged through the opened exhaust bypass hole 116, is formed in the turbine housing 112, and the valve stopper 150 may be provided at a predetermined position of the bypass flow path 118. In one form, the valve stopper 150 may be in a form of a protrusion extended from the bypass flow path 118, but not limited to this form. In this case, the exhaust bypass hole 116 functions as a kind of inlet hole that allows exhaust gas to flow to the bypass flow path 118.

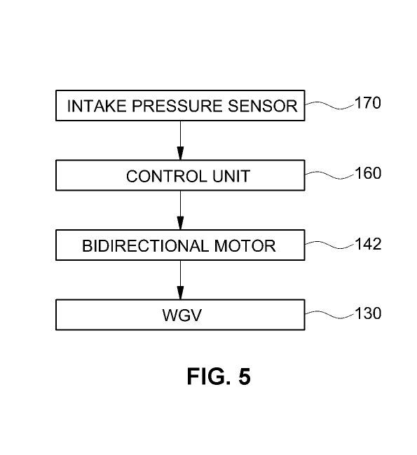

The actuator 140 is operatively connected with the waste gate valve 130 through members such as the rod 144 and the crank 146, and may include a bidirectional motor (see 142 in FIG. 5) so as to generate driving power for the waste gate valve 130 to open and close the exhaust bypass hole 116. For example, the actuator 140 may include the bidirectional motor 142 and a speed reducer (not illustrated), and selectively generates driving power for opening and closing positions of the waste gate valve 130 in accordance with a rotation direction of the bidirectional motor 142.

To control a position of the waste gate valve 130, the bidirectional motor 142 may bidirectionally operate (e.g., clockwise and counterclockwise directions), and the bidirectional motor 142 is configured to produce constant valve operating force (i.e., driving power for opening and closing the waste gate valve) by using the same driving electric current, and provide the valve operating force to the waste gate valve 130.

As illustrated in FIG. 5, the operation of the actuator 140 (specifically, the operation of the bidirectional motor) is controlled by a control unit 160. The control unit 160 controls the operation of the actuator 140 based on engine intake pressure sent to the engine side from the compressor 120, and specifically, when the engine intake pressure is equal to or higher than a predetermined pressure, the control unit 160 operates the actuator 140 to allow the waste gate valve 130 to open the exhaust bypass hole 116.

The waste gate valve 130, which opens the exhaust bypass hole 116, is rotated at a predetermined opening angle by driving power of the actuator 140, and seated on and supported by the valve stopper 150.

More specifically, the waste gate valve 130, which has opened the exhaust bypass hole 116, is supported simultaneously at both sides of the waste gate valve 130 by driving power of the actuator 140, which is applied to the valve 130 in a direction in which the valve 130 is opened, and supporting force of the valve stopper 150, and as a result, the occurrence of vibration caused by exhaust gas passing through the exhaust bypass hole 116 is inhibited or prevented.

In particular, the waste gate valve 130, which has opened the exhaust bypass hole 116 by the actuator 140, does not vibrate by being supported by the valve stopper 150.

Here, the control unit 160 may monitor engine intake pressure being supplied to an engine intake pipe by using an intake pressure sensor 170 disposed at an intercooler (not illustrated) for cooling intake air compressed by the compressor 120, and the control unit 160 determines whether the intake air is compressed more than desired when engine intake pressure is increased and becomes a predetermined pressure or higher, and then operates the actuator 140 so as to open the waste gate valve 130, thereby allowing engine intake pressure, which is compressed by the compressor 120 and with which the engine is supercharged, to be maintained at a lower level than the predetermined pressure.

When driving power (i.e., valve operating force) of the actuator 140 is applied to the waste gate valve 130 for its closing position, the valve operating force needs to be applied in a direction reverse to a flow direction of exhaust gas passing through the exhaust bypass hole 116, and as a result, the valve operating force, which is relatively larger than the valve operating force desired to move the waste gate valve 130 in the opening position, is desired.

When driving power (i.e., valve operating force) of the actuator 140 is applied to open the waste gate valve 130, the valve operating force is applied in a direction identical to a flow direction of exhaust gas passing through the exhaust bypass hole 116, and as a result, valve operating force, which is relatively smaller than the valve operating force desired to close the waste gate valve 130, is desired.

Because the waste gate valve 130 is pressed toward the exhaust bypass hole 116 by driving power of the actuator 140 when the waste gate valve 130 closes the exhaust bypass hole 116, it is possible to inhibit or prevent valve vibration and rattle noise caused by flow pressure of the exhaust gas. In one form, the waste gate valve 130 is closely attached and seated onto the exhaust bypass hole 116 in a gastight manner.

As described above, in the present disclosure, an opening degree (or an opening angle) of the waste gate valve 130 may be controlled by adopting the bidirectional motor 142, and the valve stopper 150 for supporting the waste gate valve 130 is formed at an appropriate position of the turbine housing 112 in consideration of a direction in which the waste gate valve 130 is opened. With this arrangement, it is possible to significantly reduce vibration and noise of the waste gate valve 130, and it is also possible to reduce the rattle noise caused by exhaust gas passing through the exhaust bypass hole 116 when the waste gate valve 130 is open.

Therefore, it is possible to reduce rattle noise without reducing gaps between components or additionally applying a mass damper and a spring member in order to reduce the rattle noise.

Meanwhile, the valve stopper 150 is formed on the turbine housing 112, thereby restricting an opening degree (e.g., a maximum opening angle) of the waste gate valve 130.

We have discovered that when a maximum opening degree of the waste gate valve is limited by controlling the operation of the actuator by mapping in advance, the waste gate valve may be permanently deformed and the turbine housing will be damaged because the waste gate valve may be opened to an opening degree greater than a predetermined maximum opening degree when exhaust gas passing through the exhaust bypass hole strongly presses the waste gate valve.

In the present disclosure, since the valve stopper 150 supports the rear side of the waste gate valve 130 when the waste gate valve 130 is opened at a maximum opening angle, the waste gate valve 130 is not further opened even though exhaust gas passing through the exhaust bypass hole 116 strongly presses the waste gate valve 130. The valve stopper 150 restricts the maximum opening degree of the waste gate valve 130.

In order to avoid any interference with exhaust gas flowing along the bypass flow path 118, the valve stopper 150 is sized to have a very small area compared to a cross-sectional area of the bypass flow path 118 of the turbine housing 112. And since the valve stopper 150 may be integrally formed when the turbine housing 112 is injection-molded, there is no difficulty in manufacturing the valve stopper 150. For example, the valve stopper 150 may be formed by partially changing a mold for injection molding of the turbine housing 112, and it is not necessary to add a separate sliding core for forming the valve stopper 150 to the mold.

According to the present disclosure, factors causing the rattle noise of the turbocharger can be removed by easily changing a structure of the turbine housing 112 as described above.

The present disclosure has been described in detail with reference to exemplary forms. However, it will be appreciated by those skilled in the art that changes may be made in these forms without departing from the principles and spirit of the present disclosure.

Reference numerals set forth in the Drawings include reference to the following elements as discussed above:
100: turbocharger
110: turbine
112: turbine housing
114: turbine wheel
116: exhaust bypass hole
118: bypass flow path
120: compressor
122: compressor housing
124: compressor wheel
130: waste gate valve
140: actuator
142: bidirectional motor
144: rod
146: crank
150: valve stopper
160: control unit
170: intake pressure sensor

What is claimed is:

1. An apparatus for reducing rattle noise of an automotive turbocharger, the apparatus comprising:
a waste gate valve configured to open and close an exhaust bypass hole formed in a turbine housing;
an actuator configured to operate the waste gate valve by driving power generated by the actuator;
a valve stopper formed on the turbine housing, and configured to support the waste gate valve; and
a control unit configured to control the actuator.

2. The apparatus of claim 1, wherein the actuator includes a bidirectional motor configured to selectively generate driving power for opening and closing the waste gate valve.

3. The apparatus of claim 1, wherein the control unit controls the actuator based on engine intake pressure.

4. The apparatus of claim 3, wherein when the engine intake pressure is equal to or higher than a predetermined pressure, the control unit operates the actuator to allow the waste gate valve to open the exhaust bypass hole.

5. A method for reducing rattle noise of an automotive turbocharger, the method comprising:
a first step of detecting engine intake pressure compressed and generated by a turbocharger;
a second step of operating an actuator configured to operate a waste gate valve based on the engine intake pressure, the waste gate valve configured to open and close an exhaust bypass hole of the turbocharger; and
a third step of supporting the waste gate valve in an open position thereof by a valve stopper.

6. The method of claim 5, wherein, in the second step, the waste gate valve opens the exhaust bypass hole when the engine intake pressure is equal to or higher than a predetermined pressure.
